(19) United States
(12) Patent Application Publication
(10) Pub. No.: US 2008/0246179 A1
(43) Pub. Date: Oct. 9, 2008

(54) Composition and Method of Using the Same to Make a Simulated Rock Climbing Wall

(76) Inventors: Jay G. Beckwith, Sebastopol, CA (US); Gary McCall, Redding, CA (US); Paul D'Amico, Redding, CA (US)

Correspondence Address: STAINBROOK & STAINBROOK, LLP, 412 AVIATION BOULEVARD, SUITE H, SANTA ROSA, CA, 95403, US

(21) Appl. No.: 11/817,862

(22) PCT Filed: Mar. 7, 2006
(86) PCT No.: PCT/US06/08730

§ 371 Date: Sep. 5, 2007

Related U.S. Application Data
(60) Provisional application No. 60/659,514, filed on Mar. 7, 2005.

(51) Int. Cl. B29C 33/40; A63B 9/00

(52) U.S. Cl. 264/219; 106/672

(57) ABSTRACT

A composition and method for making a simulated rock climbing, including the steps of making a mold for a basic shape for a rock climbing wall casting, filling the mold with cellular concrete; allowing the concrete to cure partially and inverting it in a bed of sand, removing the mold to expose the simulated rock climbing wall casting; sandblasting the simulated rock climbing wall casting into its general finished shape; and using concentrated sandblasting to form integral recesses and protrusions comprising various hand holds.

### BACKGROUND OF THE INVENTION

1. Technical Field

The present invention relates generally to rock climbing walls, and more particularly to a climbing wall that employs a novel composition of fiber reinforced porous polymeric cement to create a lightweight simulated rock structure requiring no steel reinforcing bars or other massive framework and that lends itself to easy shaping and maintenance by sandblasting either during manufacture or at the installation site.

2. Background Art

Climbing can be categorized into several ways, and a common classification scheme differentiates climbing types by climbing area. In this scheme, climbing is divided into mountaineering or mountain climbing, ice climbing, bouldering, indoor climbing, and rock climbing. Rock climbing has now become a major participant sport. It is further divided into several subcategories, including, among others, traditional climbing, indoor climbing, and bouldering. It is a dangerous sport which demands elite fitness levels and technical expertise.

In order to practice and refine climbing techniques in a relatively safe environment, climbers frequently use indoor climbing walls. Climbing walls provide interested climbers with a climbing experience in a convenient and generally safe environment, such as an indoor climbing wall facility, a park, or at a health club. The popularity of climbing walls is increasing exponentially. Indeed, the use of climbing walls is no longer the sole province of expert climbers practicing their passion; climbing walls are now used even by children and casually interested climbers. The inherent pleasure of climbing is remarkably well satisfied with artificial climbing surfaces, and the experience is significantly enhanced by simulating natural rock.

The prior art shows a few broad types of climbing walls employed to simulate rock climbing activity. The first is a generally vertical wall onto which hand and foot holds are directly bolted. The wall element may be anything from plywood panels to simulated rock, but in each case hand holds are bolted onto the generally vertical surface.

The second type is a generally vertical surface fabricated from a framework onto which simulated rock surface is applied, either in panels or through a molding or deposition process. In both instances, the type and difficulty of climb is governed by the placement and the kinds of holds affixed to or molded into the surface. And, in both instances, the walls are massive structures fabricated from heavy construction materials designed to withstand large compressive loads. In fact, the construction philosophy has been driven largely by the need to make engineered walls capable of erection in significant heights. For a free standing wall, this necessitates the use of a heavy framework or substructure of reinforcement steel or comparable material. Interestingly, the choice of materials and the approach to design has been carried over and applied even when a relatively low wall or climbing surface is called for—for instance when a more horizontal climbing experience (“boldering”) is envisioned—or when the wall is intended for use primarily by children. As a result, the rock climbing walls currently in use are still massive, difficult to transport, expensive to manufacture, and extremely difficult to modify after installation.

A few manufacturers have employed glass fibre reinforced concrete in creating climbing wall products, but the systems are generally thin shell systems having a metal substructure. For instance, Nicros, Inc., of St. Paul, Minn. employs fiberglass fibers to reinforce a cement combined with an acrylic polymer, though the fibers are simply mixed in with a Portland cement-based plaster mix, along with the acrylics. The fibers are generally only one to two inches in length because they are used in a thin shell and cannot be exposed.

Nicros, Inc. also manufactures a wall it terms the A.R.T.WALL™. These walls are built on a heavy duty primary steel frame onto which 6×6 or 7×7 foot panels of glass fiber reinforced concrete rocks castings are attached. Secondary steel wire is used to attach the rock casting panels to the primary frame. Cracks between the panels are closed with an embossing process, and then modifications can be made to the rock background surface. The surface is then stained to simulate rock. Modular handholds can then be bolted onto the wall using threaded bolt holes incorporated into the castings. Rope stations at the top of the wall and handholds are installed at the landing surface.

While providing a realistic rock climbing experience, the above-described A.R.T. WALL™ requires that rock castings be made to fabricate panels for installation on the primary frame. Furthermore, recesses and protrusions are defined by the rock employed for the cast mold. It would be preferable to employ a method of manufacturing a simulated climbing wall that did not require any exemplar for casting and that eliminated the need for modular hand hold attachments.

Other limitations in the prior art reside in the approaches to structure design itself. To date, most structures intended for climbing activities by children have not been designed to simulate natural rock. One kind of children's climbing structure comprises a plurality of geometrically shaped units with openings joined together in a configuration that encourages children to climb and maneuver about the structure. In effect, these are playground structures that are elaborations and developments of the prior “monkey bar” structures. In another kind of children's climbing structure, a constellation of ropes and nets are disposed in combinations of vertical, angled, and flat orientations. Unfortunately, both types of structures do not simulate a rock climbing experience at all. Worse, net and rope climbing, without more, can be outright boring because of the spacing and regularity of the rope strands. Furthermore, the materials employed in the geometric structures (generally plastics and metals) are prone to become slippery and to provide poor gripping surfaces.

To some extent problems with degrading gripping surfaces plague even the more elaborate and “realistic” structures intended for use by experts. Holds have evolved significantly in recent years to include elegant designs fashioned to mimic the kinds of textures and surfaces one would encounter in very particular kinds of climbs—vertical rock walls, caves, ice, etc. The holds provide a variety of pulling features, and may include numerous ridges and valleys to offer such pulls as thumb catches, sidepulls, pinches, underclings, and crimps.

However, the method of affixing the hold to the climbing surface has not changed—they are bolted on. And when a hold become worn or degrades because of wear or even an unsafe build up of body oils, the hold must be removed, cleaned, and replaced. Furthermore, modular hand holds do not “feel” like the holds made over geological time by rock formation and erosion processes.

The following patents are typical of prior art climbing walls and holds for climbing walls:

U.S. Pat. No. 6,709,365, to Zeilinger, discloses an imitation climbing rock for children which is adapted to be attached to a wall to simulate a natural rock-like structure.

U.S. Pat. No. 5,254,058, to Savigny, teaches a modular rough surface of a climbing wall formed from the assembly of panels having specific curved structures, and arranged in a plurality of levels. The curved structure of each standard panel with holds comprising either hollow or prominent sculptures cast with the panel, or removable holds secured to the panel by means of fixing screws or bolts. The rough surface is secured in the rear to a fixed support by means of a metal connecting framework equipped with tubular bars. The fixed support is formed by an existing wall on which profiled rails are placed to fix the bars of the framework, but it is noted that a scaffolding system could also be used.

U.S. Pat. No. 6,402,663, to Popp, teaches a climbing wall that includes grips designed to allow a child to maneuver safely around on the climbing wall. It has a front surface, a rear surface and at least one intermediate portion reaching between the front surface and the rear surface to define one or more openings which extend through the climbing wall. The openings are located in positions that allow a child to travel safely around on the climbing wall. The front and rear surfaces can be textured to have a rock-like appearance, and each of the openings has an irregular shape in order to facilitate the simulation of outdoor rock climbing activity.

U.S. Pat. No. 6,419,610, to Jonas, shows a truncated triangular inclined climbing wall attached to a wooden play structure. The climbing wall is staked to the ground, and narrows from a wide, ground-engaging, base, to a narrower summit, which is immediately adjacent the framed inlet. It includes a number of rock-simulative ledges progressing from the base to the summit. To contribute to the rock-simulative visual effect of the “thermoformed” plastic assembly, polyethylene is extruded with a pattern of streaks or striations which, when molded, simulate the color variations of naturally occurring rock formations.

An interesting departure from the foregoing art is found in U.S. Pat. No. 6,551,216, to Rennex, which discloses a rock-climbing structure including one or more pliable climbing matrices held under tension, and further including a plurality of rock-climbing/gymnastic holds attached to the pliable climbing matrices. The climbing matrix is a net or a sheet and a plurality of holds are attached to pliable climbing matrix, the holds including a hold edge, a jib hold, a hold hole, a hold lip, a hold crack, or a hold boss.

The foregoing patents and the above-mentioned A.R.T. WALL™ reflect the current state of the art of which the present inventor is aware. Reference to, and discussion of, these patents and products is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### DISCLOSURE OF INVENTION

The present invention is a novel use of polypropylene fiber reinforced cellular concrete and a method of using the same to make simulated rock climbing walls. The composition is ideally suited for molding a cast for a simulated rock boulder or free standing wall, and then shaping and sculpting the cast with sandblasting processes to create a natural feeling and natural looking simulated rock climbing wall. This process results in a simulated rock climbing wall that entirely eliminates the need for artificial modular hand holds, which cannot closely imitate the feel of holds produced by moving water, wind, organisms, temperature change, and gravity. The simulated rock climbing wall of the present invention provides users with permanent hand and foot holds and grips that mimic the grips and holds made over millions of years through rock formation, rock erosion, and rock weathering processes.

It is therefore an object of the present invention to provide a new and improved composition and a method of using the same to produce a simulated rock climbing wall.

It is another object of the present invention to provide a new and improved composition and a method of using the same to produce a simulated rock climbing wall that does not employ modular hand holds as a primary feature.

A further object or feature of the present invention is a new and improved composition and a method of using the same to produce a simulated rock climbing wall that employs lightweight, heavy load-bearing cellular concrete reinforced with polymeric fibers.

An even further object of the present invention is to provide a novel composition method of using polymeric fiber reinforced cellular concrete to produce a simulated rock climbing wall having hand holds made through a sand blasting process.

There has thus been broadly outlined the more important features of the invention in order that the detailed description that follows may be better understood, and in order that the present contribution to the art may be better appreciated. Additional objects, advantages and novel features of the invention will be set forth in part in the description as follows, and in part will become apparent to those skilled in the art upon examination of the following. Furthermore, such objects, advantages and features may be learned by practice of the invention, or may be realized and attained by means of the instrumentalities and combinations particularly pointed out in the appended claims.

Still other objects and advantages of the present invention will become readily apparent to those skilled in this art from the following detailed description, which shows and describes only the preferred embodiments of the invention, simply by way of illustration of the best mode now contemplated of carrying out the invention. As will be realized, the invention is capable of modification in various obvious respects without departing from the invention. Accordingly, the description of the preferred embodiment is to be regarded as illustrative in nature, and not as restrictive.

### BEST MODE FOR CARRYING OUT THE INVENTION

The present invention is a composition for making a simulated rock climbing wall and the method of using the composition to make such a structure. The composition is polymeric fiber reinforced cellular concrete, and bears the proprietary name PolyFiberCrete™. The cellular concrete in the composition is reinforced with polymeric fibers up to six inches in length. The composition shall be referred to herein as “PFRCC.”

Preferably the cellular concrete employed in the inventive process is of the type manufactured under the system sold by MIRACON® Technologies, Inc. and has a compressive strength ranging between 2,000 and 5,000 psi. The MIRACON® system is a foam generating system for lightweight concrete. Conventional concrete poured at 150 pounds per cubic foot achieves compressive strength rating in excess of 2,500 psi. When the of MIRACON® cellular concrete system is employed, compressive strengths over 2,500 psi can be achieved when the mixture is poured at weights as low as 90 psi. Preferably the unit weight is between 80 psi and 120 psi, at which weights the desired compressive strengths are achieved.

Alternatively, a more standard concrete mix (comprising cement, aggregate, and water) can be used and selected materials can be added to create micro-voids into the mix. For instance, polystyrene, perlite, glass spheres, or even air, either alone or in some combination thereof, can be added to the concrete mix so as to achieve a product that closely mimics a natural sandstone composition. Preferably the reinforcement fibers are polyester and/or polypropylene fibers, such as the STRUX® synthetic macro fiber reinforcement manufactured and sold by W.R. Grace & Company. However, nylon fibers could be employed, as well, as a fundamental objective is to eliminate exposed metal surfaces that are vulnerable to corrosion and unnatural in their feel to users. Another fundamental objective is to provide a simulate rock substrate that possesses sufficient load-bearing capacity for safety when used as a rock climbing wall, but which also permits economical shaping with mechanical tools and sand blasting equipment after curing.

The above-described novel composition provides strong, lightweight material when cured, and which conforms to C1116-03 Standard Specification for fiber-reinforced concrete. This makes it possible to manufacture thick simulated rock structures, and in smaller installations, the polypropylene fiber reinforcement obviates the need for structural steel to provide a substructure for the climbing wall. This facilitates in-plant manufacture and simple truck and trailer transportation to an installation site. Furthermore, the surface of the wall is amenable to both gross and fine precision sandblasting for forming and contouring hand and foot holds.

To manufacture a climbing wall from the above-described material, a model is made of the climbing wall—“The Plug”—in the basic shape desired. The plug forms the basis of a mold. Mold release is painted on the plug. When the mold is a multi-part mold, the next step comprises adding “dams,” created by using thin aluminum sheets approximately three inches high inserted roughly ½-in into the plug. Areas of negative draft are located and filled with flexible rubber that will become a removable part of the mold. Fiberglass is then laid over the plug in a thickness sufficient to restrain the pressure of the concrete. The mold is broken apart at the dams. The plug is removed, cleaned and then repositioned in its original form. The soft rubber inserts from the negative draft areas are removed and attached to the mold in such a way that this can remain in the casting when the mold is removed for extraction as a second step. Holes are drilled through the flanges created by the dams that will accept the bolts that now hold the mold together. The mold is now ready to receive the PFRCC mix.

Once filled and partially cured, the mold is turned upside down in a bed of sand and the mold removed. The soft rubber inserts are removed. Significant flashings, if any, at the mold part lines are ground away.

The simulated rock casting is then sculpted into its desired general shape by sandblasting using a variety of blast nozzles and generally dry sandblasting media to open surface pores and soften any sharp edges. The sculpted casting is then further sculpted and shaped to add additional hand and foot hold depressions by concentrated sandblasting in predetermined areas to dig out recesses and form protrusions comprising the various holds. The goal of the technician performing this work is to sculpt the PFRCC surface to simulate as closely as possible the natural effects of physical and chemical rock formation, weathering, and erosion processes on various climbing rock surfaces, such as granite and sandstone. In this manner, such dramatic processes as tafoni (or cavernous weathering) may be simulated, as well as subtle processes such as splash erosion and eolian erosion.

The final step in fabricating the inventive simulated rock climbing wall comprises adding stains that replicate the staining which occurs in stone over time as rain leaches out chemicals and lichens grow on the surface. These final steps can occur at the place of manufacture or in the field after installation. The ability to refinish the installation in the field without a concern about exposing reinforcement steel or other “hidden” structural components allows for new handholds to be added or the texture on the areas which are gripped in climbing to be refreshed as needed.

Having fully described several embodiments of the present invention, many other equivalents and alternative embodiments will be apparent to those skilled in the art. These and other equivalents and alternatives are intended to be included within the scope of the present invention.

What is claimed as invention is:

1. A composition for making a simulated rock climbing wall, comprising concrete reinforced with polymeric fibers.

2. The composition of claim 1, wherein said concrete is cellular concrete.

3. The composition of claim 2, wherein said cellular concrete has a compressive strength ranging between 2,000 and 5,000 psi.

4. The composition of claim 3, wherein said cellular concrete has a unit weight of between

5. The composition of claim 1, wherein said concrete is standard concrete with an additive selected from the group consisting of polystyrene, perlite, glass spheres, air, alone or in some combination, to create microvoids in the cured composition and thus to achieve a product that closely mimics a natural sandstone composition.

6. The composition of claim 1, wherein said reinforcement fibers are selected from the group consisting of polyester and polypropylene fibers.

7. The composition of claim 1, wherein said reinforcement fibers are nylon fibers.

8. A method of making a simulated rock climbing wall, comprising the steps of:
(a) making a mold for a simulated rock climbing wall casting;
(b) filling the mold with concrete;
(c) allowing the concrete to cure partially;
(d) inverting the mold;
(e) placing the inverted mold in a bed of sand;
(f) removing the mold to expose the simulated rock climbing wall casting;
(g) sandblasting the simulated rock climbing wall casting into its general finished shape; and
(h) using concentrated sandblasting to form recesses and protrusions comprising various hand holds.

9. The method of claim 8, further comprising the step of grinding away any flashings at the mold part lines after step (f).

10. The method of claim 8, further including the step of adding stains to color the simulated rock climbing wall after step (h).

11. The method of claim 8, wherein step (a) comprises the steps of:
(aa) making a plug in the desired basic shape;
(bb) painting mold release on the plug;
(cc) inserting dams into the plug;
(dd) locating and filling areas of negative draft with rubber inserts;
(ee) laying fiberglass over the plug in a thickness sufficient to restrain the pressure of cellular concrete having a predetermined unit weight;
(ff) allowing the fiberglass to cure;
(gg) breaking apart the mold at the dams;
(hh) removing the rubber inserts;
(ii) attaching the rubber inserts to the mold such that they will remain in the casting when the mold is removed for extraction as a second step; and
(jj) drilling holes through flanges created by the rubber dams for accepting bolts to hold the mold together during concrete casting.

12. The method of claim 11, wherein said step of inserting dams comprises inserting thin aluminum sheets approximately one half inch into the plug.

13. The method of claim 8, wherein step (b) comprises pouring cellular concrete into the mold.

14. The method of claim 13, wherein the cellular concrete has a unit weight between 80 and 120 psi.
